(19) United States
(12) Patent Application Publication
(10) Pub. No.: US 2007/0170345 A1
(43) Pub. Date: Jul. 26, 2007

(54) ICE TRAY UNIT AND METHOD OF MANUFACTURING THE SAME

(75) Inventors: Akinori TSUJIMOTO, Mie (JP); Masatoshi SHOUKYUU, Shiga (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/626,544

(22) Filed: Jan. 24, 2007

(30) Foreign Application Priority Data
Jan. 25, 2006 (JP) JP 2006-015918

(51) Int. Cl. B22C 9/08; B29C 33/56; F25C 1/22

(52) U.S. Cl. 249/114.1; 62/340; 249/105

(57) ABSTRACT

An ice tray unit is configured to be used in a refrigerator. The ice tray unit includes a mounting section configured to be mounted to the refrigerator, and a tray coupled to the mounting section. The tray is made of metal. The tray includes a box section configured to pool water, and partition plates coupled with the box section. The tray is independent from the mounting section. The partition plates are independent from the box section. The ice tray unit provides a die for manufacturing it with a large durability.

### FIELD OF THE INVENTION

The present invention relates to an ice tray unit including an ice tray for making ice and placed in a freezer compartment of a refrigerator, and to a method of manufacturing the ice tray unit.

### BACKGROUND OF THE INVENTION

FIG. 7 is a perspective view of a conventional ice tray 1 disclosed in Japanese Patent Laid-Open Publication No. 2001-272146. FIG. 8 is a sectional view of ice tray 1 at line 8-8 shown in FIG. 7. Ice tray 1 is made of aluminum alloy having a high heat-conductivity, and formed by die-casting the aluminum alloy. Ice tray 1 is placed in a freezer compartment of a refrigerator. Ice tray 1 includes cells 2 for pooling water temporarily and mounting sections 5 unitarily molded with cells 2. Mounting sections 5 are fixed to a wall of the refrigerator with screws. Cells 2 adjacent to each other communicate with each other through cut-out portion 3. As shown in FIG. 8, heater 4 is crimped or screwed on an under surface of ice tray 1.

An operation of ice tray 1 will be described below.

Water is supplied to ice tray 1 and flows through cut-out portion 3 between cells 2, then being distributed into all cells 2. Each cell 2 contains about 15 ml of the water, thus having the ice tray including seven cells 2 contain about 105 ml of the water. The water in ice tray 1 is cooled down gradually by heat dissipation due to the transferring of heat from the surface of the water, and conducting and radiating heat from a wall of ice tray 1, and then freezes to change into ices.

Being energized, heater 4 causes the ices in ice tray 1 to melt, and the ices are taken out from ice tray 1 with claws for taking out the ices.

Ice tray 1 is formed by aluminum die-cast forming. The die for this aluminum die-cast wears remarkably at the melting temperature (about 600° C.) of aluminum, hence having a short life time. Cells 2 and mounting sections 5 are unitarily die-casted. Consequently, if mounting section 5 is changed according to customer's request, new dies are necessarily prepared even if the size of an ice is not changed. The shape of cell 2 is determined by the die. In order to obtain different sizes of ices, another die is needed.

### SUMMARY OF THE INVENTION

An ice tray unit is configured to be used in a refrigerator. The ice tray unit includes a mounting section configured to be mounted to the refrigerator, and a tray coupled to the mounting section. The tray is made of metal. The tray includes a box section configured to pool water, and partition plates coupled with the box section. The tray is independent from the mounting section. The partition plates are independent from the box section.

The ice tray unit provides a die for manufacturing it with a large durability.

### BRIEF DESCRIPTION OF THE DRAWINGS

FIG. 1A is a perspective view of an ice tray unit in accordance with an exemplary embodiment of the present invention.

FIG. 1B is a schematic diagram of a refrigerator including the ice tray unit in accordance with the embodiment.

FIG. 2 is a perspective view of an ice maker including the ice tray unit in accordance with the embodiment.

FIG. 3 is a perspective view of a tray of the ice tray unit in accordance with the embodiment.

FIG. 4 is a perspective view of an essential part of the tray of the ice tray unit in accordance with the embodiment.

FIG. 5 is a sectional view of the tray of the ice tray unit at line 5-5 shown in FIG. 3.

FIG. 6 is a perspective view of an essential part of the tray of the ice tray unit in accordance with the embodiment.

FIG. 7 is a perspective view of a conventional ice tray.

FIG. 8 is a sectional view of the ice tray unit at line 8-8 shown in FIG. 7.

### DETAIL DESCRIPTION OF THE PREFERRED EMBODIMENT

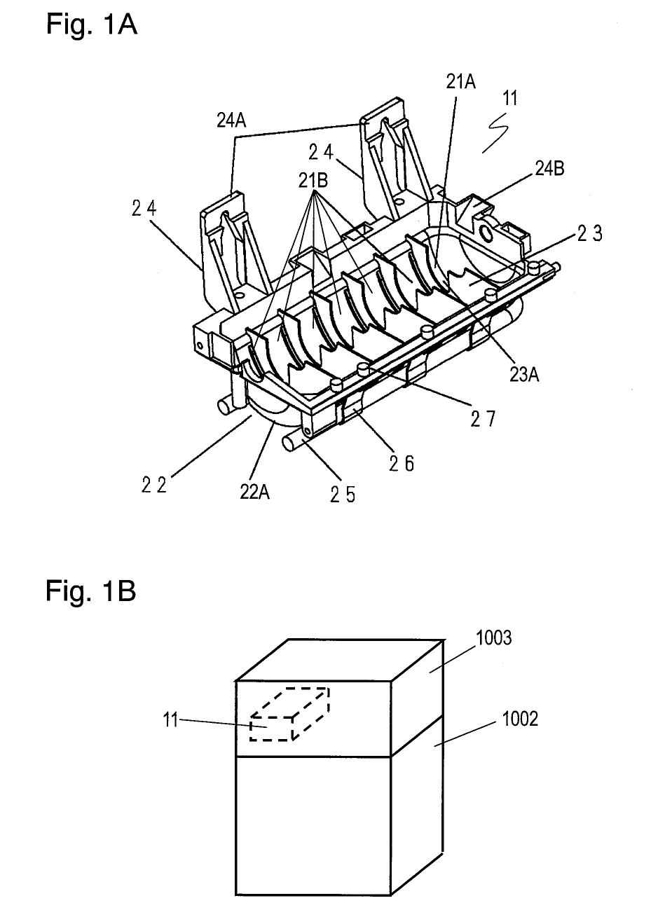

FIG. 1A is a perspective view of ice tray unit 11 in accordance with an exemplary embodiment of the present invention. FIG. 1B is a schematic diagram of refrigerator 1002 including ice tray unit 11. Ice tray unit 11 is configured to be used in refrigerator 1002 and is placed in freezer compartment 1003 of refrigerator 1002. Ice tray unit 11 includes two mounting sections 24 and tray 31 made of metal. Tray 31 is a member independent from mounting section 24.

Tray 31 includes box section 22 including seven cells 21A and 21B, and six partition plates 23 configured to be coupled with box section 22. Each of cells 21A and 21B of box section 22 is configured to pool water, and has bottom 22A having a semicircular shape. Partition plates 23 are members independent from box section 22. Each of partition plates 23 has cut-out portion 23A through which the water can move back and forth in cells 21A and 21B. Box section 22 and partition plates 23 are made of highly heat conductive material, such as aluminum.

Mounting section 24 is configured to be mounted to refrigerator 1002. Mounting section 24 includes fixed portion 24A configured to be fixed onto a wall of freezer compartment 1003 with screws, and has water inlet 24B through which the water is supplied from a water feed valve to cell 21A. Mounting section 24 is made of resin, such as ABS resin.

Heater 25 is mounted to mounting section 24 via mounting plates 26 with screws 27 together with box section 22.

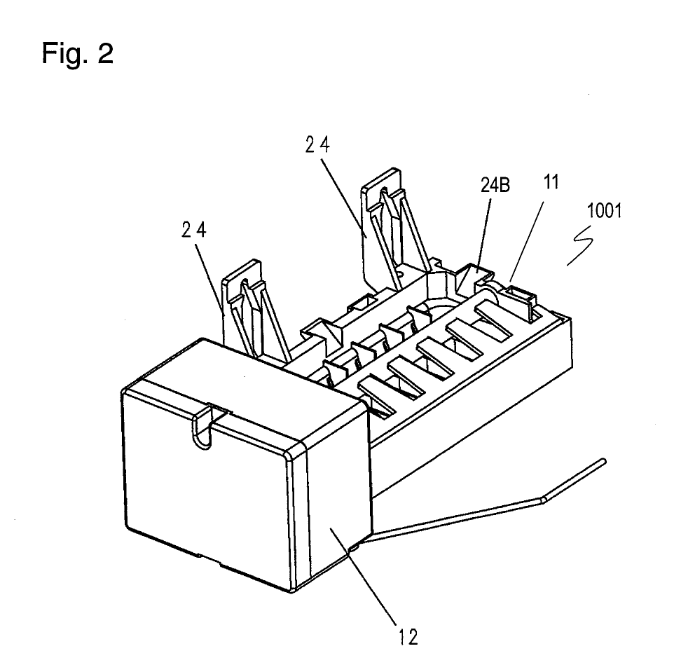

FIG. 2 is a perspective view of icemaker 1001 including ice tray unit 11. Icemaker 1001 includes ice tray unit 11 and icemaker mechanism 12. Icemaker mechanism 12 includes an ice ejector, a temperature sensor, an ice-stock detector, and a controller. The ice ejector takes out ices produced in tray 31. The temperature sensor detects a temperature of ice tray unit 11. The ice-stock detector detects an amount of ices produced in tray 31.

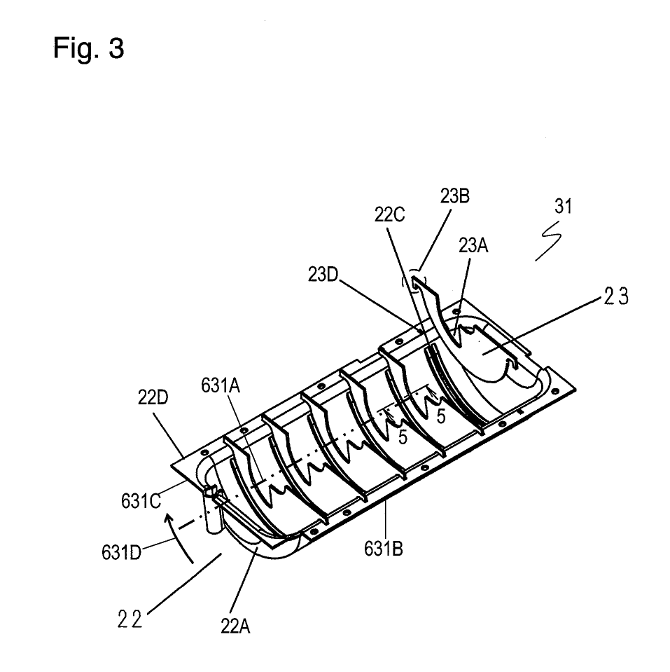

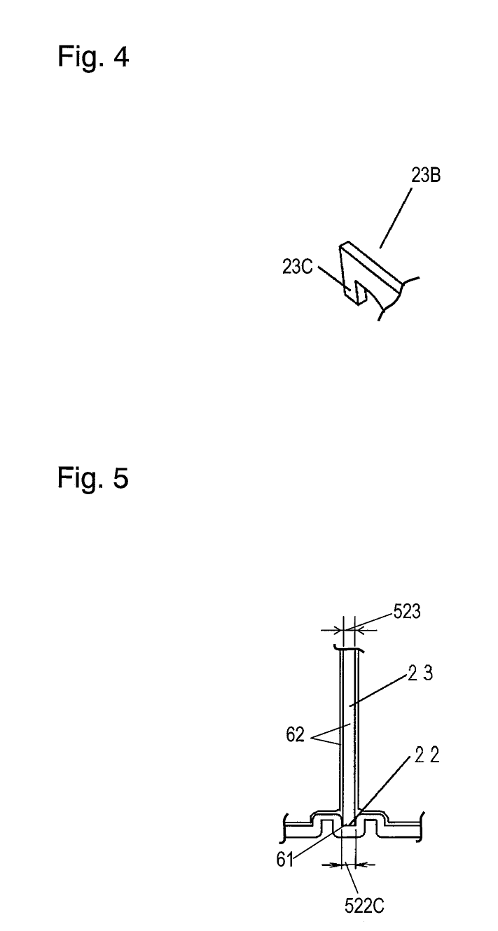

FIG. 3 is a perspective view of tray 31. FIG. 4 is a perspective view of an essential part of tray 31. Tray 31 has substantially a rectangular shape having long side 631B in parallel with center axis 631A of the semi-circular shape of bottom 22A, and short side 631C perpendicular to long side 631B. Each of partition plates 23 has projection 23C projecting downward at end 23B of plate 23. Box section 22 has rectangular holes 23D provided in outer periphery 22D of box section 22. Each projections 23C is engaged with each of holes 23D, and is crimped with a tool so as to fix partition plates 23 to box section 22. This structure reliably positions partition plates 23 and fixes plates 23 to box section 22, thus allowing partition plates 23 to be held reliability.

FIG. 5 is a sectional view of tray 31 of ice tray unit 11 at line 5-5 shown in FIG. 3. Bottom 22A of box section 22 has six grooves 22C provided therein. Groove 22C has width 522C identical to thickness 523 of partition plate 23. Six grooves 22C are equidistantly placed from each other and extend in parallel with circumference direction 631D of the semicircular shape of bottom 22A of tray 31. Six partition plates 23 are inserted into six grooves 22C, respectively. Grooves 22C position partition plates 23 easily, hence producing the ices having uniform sizes.

Film 62 is provided on box section 22 and partition plates 23. Film 62 is formed after box section 22 and plates 23 are jointed together, thereby covering boundary 61 between box section 22 and plates 23 entirely. Film 62 increases corrosion resistance of tray 31, and smoothes surfaces of cells 21A and 21B, accordingly allowing heater 25 to heat the ices uniformly via tray 31. Film 62 fills a gap between plates 23 and box section 22, thereby preventing the water from remaining in the gap. Film 62 may be a plated film formed by plating, or a painted film formed by painting.

Box section 22 and plates 23 are jointed together, and then, are plated or painted, thereby increasing the corrosion resistance of tray 31 and smoothing the surfaces of cells 21A and 21B. This process allows heater 25 to heat the ices uniformly via tray 31, and allows the ices to be taken out easily. The plating or painting fills the gap between box section 22 and plates 23, thereby preventing the water from remaining in the gap.

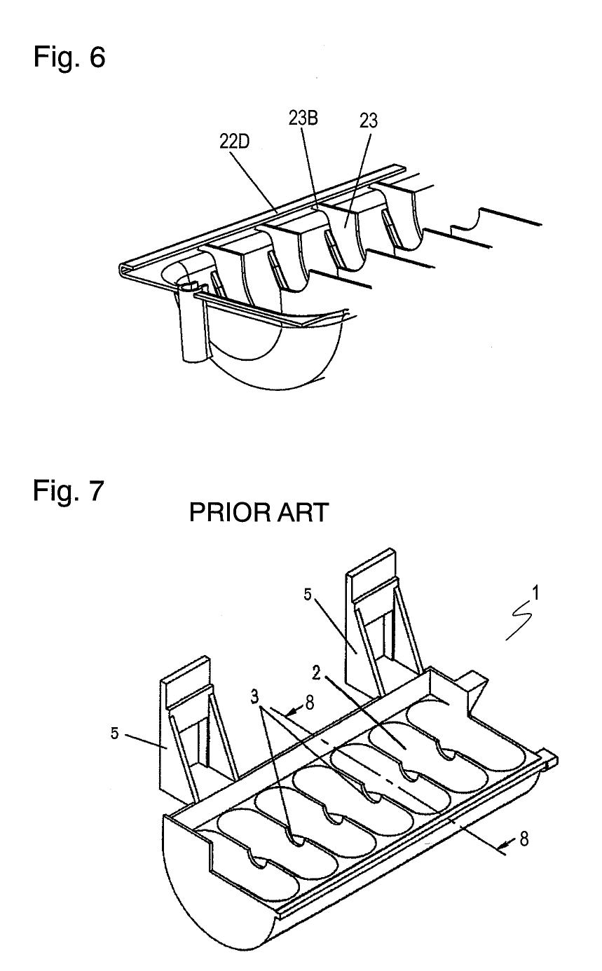

FIG. 6 is a perspective view of an essential part of tray 31. Outer periphery 22D of box section 22 is bent to have a bent shape having a U-shape to cover end sections 23B of partition plates 23, so that end sections 23B are crimped with the U-shape, the bent shape, of outer periphery 22D bent. Thus, outer periphery 22D of box section 22 is bent once to fix partition plates 23 to tray 31, thus allowing tray 31 to be assembled in a small numbers of steps.

An operation of ice tray unit 11 will be described below.

Water is supplied from a water feed valve via water inlet 24B into one cell 21A of seven cells 21A and 21B defined by partition plates 23 of tray 31. The water flows into adjacent cells 21B via cut-out portion 23A provided in partition plate 23, and is distributed into all of seven cells 21A and 21B. Each of cells 21A and 21B contains about 15 ml of the water, thus seven cells 21A and 21B contain about 105 ml of the water in total.

The water supplied to cells 21A and 21B is facilitated to cool down due to the heat conductivity of tray 31, thereby making ices in a short time. After the ices are made, heater 25 is turned on for heating tray 31 to remove the ices from tray 31, and then, the ices are taken out with the claw of the ice ejector.

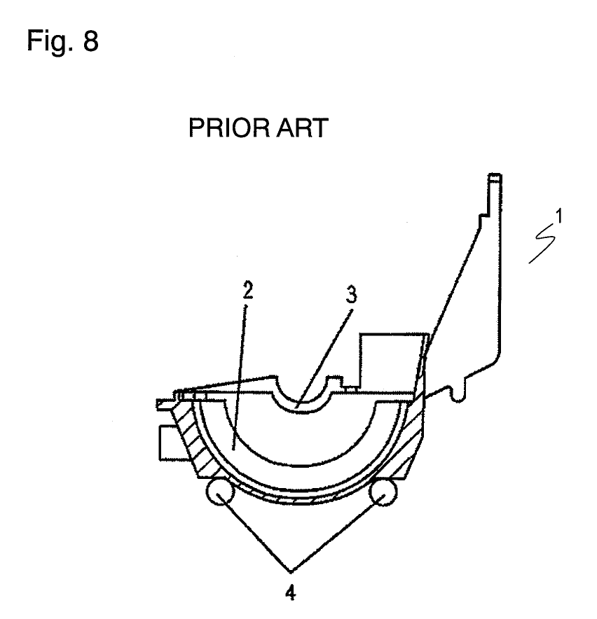

Box section 22 is formed by pressing and drawing a metal plate, such as an aluminum plate. A press die generally has a life ten times as long as a die-cast molding die. Thus, each die for manufacturing box section 22 and partition plate 23 independent from box section 22 has a life longer than that of a die-cast molding die for manufacturing conventional tray 1 shown in FIGS. 7 and 8.

Mounting section 24 configured to be mounted to the refrigerator is a member independent from tray 31, and is made of resin. Dies for making mounting section 24 are produced to allow ice tray unit 11 to be mounted to various refrigerators. Tray 31 can be used in these refrigerators, and consequently, the die for tray 31 can be used commonly among the refrigerators, thereby reducing cost of the die. The melting temperature of the resin for molding the resin is lower than about 300° C., and prevents the die from wearing. Thus, the die for manufacturing mounting section 24 made of the resin has a life longer than that of conventional ice tray 1 shown in FIG. 7 and FIG. 8. Mounting section 24 made of the resin is formed by an outsert molding method, i.e., by injecting the resin around tray 31 placed in the die, thereby mounting section 24 is formed and fixed to tray 31 at once, thus reducing the number of processes of assembling ice tray unit 11.

Ice tray unit 11 can change the number of partition plates 23 to change the sizes of the ices easily.

As shown in FIGS. 3 and 4, rectangular holes 23D are provided in outer periphery 22D of box section 22 of metal tray 31. Projections 23C projecting downward from end sections 23B of partition plates 23 are engaged with rectangular holes 23D, respectively, and are crimped together. This process positions partition plates 23 and fixes plates 23 to box section 22, hence allowing the partition plates to be held reliably.

Water inlet 24B for feeding the water into tray 31 is provided at mounting section 24, and prevents the water from splashing around ice tray unit 11 when the water is supplied from the water feed valve into tray 31.

According to this embodiment, tray 31 and partition plates 23 are made of highly heat conductive material, such as aluminum, and may be made of copper instead of aluminum. Mounting section 24 is made of ABS resin, and maybe made of general plastic, such as polypropylene resin.

According to this embodiment, tray 31 of ice tray unit 11 is partitioned with six partition plates 23 into seven cells 21A and 21B, hence producing seven ices. This number may be changed according to requirement. For instance, partition plates 23 may be inserted into six grooves 22C alternately, thereby producing ices larger than the ices made in tray 31 having six partition plates 23 attached thereto.

According to this embodiment, six grooves 22C are equidistantly placed from each other in parallel. The intervals between the grooves adjacent to each other may be different from each other, hence making ices having sizes different from each other.

The ice tray unit according to this embodiment provides a die for manufacturing it with a large durability, and is useful in refrigerators.

What is claimed is:

1. An ice tray unit configured to be used in a refrigerator, said ice tray unit comprising:
a mounting section configured to be mounted to the refrigerator; and
a tray made of metal and coupled to the mounting section, the tray being independent from the mounting section, the tray including
a box section configured to pool water, and
a plurality of partition plates coupled with the box section, the plurality of partition plates being independent from the box section.

2. The ice tray unit according to claim 1, wherein the mounting section is made of resin.

3. The ice tray unit according to claim 1, wherein the box section has a bottom having a plurality of grooves provided therein, and the plurality of partition plates are inserted into the grooves, respectively.

4. The ice tray unit according to claim 3, wherein intervals between grooves of the plurality of the grooves adjacent to each other are different from each other.

5. The ice tray unit according to claim 1, wherein
the plurality of partition plates have end sections thereof having projections, respectively, and
the box section has an outer periphery having a plurality of holes provided therein, the plurality of holes being engaged with the projections, respectively.

6. The ice tray unit according to claim 5, wherein the box section is coupled with the partition plates by engaging the projections of the plurality of partition plates with the plurality of holes, respectively, and crimping the projections.

7. The ice tray unit according to claim 5, wherein
the outer periphery of the box section has a bent shape, and
the end sections of the partition plates are crimped with the outer periphery.

8. The ice tray unit according to claim 1, wherein
the box section has an outer periphery which is bent, and
the plurality of partition plates have end sections crimped with the bent outer periphery.

9. The ice tray unit according to claim 1, further comprising a film provided on the box section and the plurality of partition plates, the film covering a boundary between the box section and the partition plates.

10. The ice tray unit according to claim 9, wherein the film comprises a plated film.

11. The ice tray unit according to claim 9, wherein the film comprises a painted film.

12. The ice tray unit according to claim 1, further comprising a heater for heating the tray.

13. The ice tray unit according to claim 1, wherein the mounting section has a water inlet for supplying water to the tray.

14. A method of manufacturing an ice tray unit configured to be used in a refrigerator, said method comprising:
providing a mounting section configured to be mounted to the refrigerator;
providing a tray configured to pool water by coupling a plurality of partition plates with a box section made of metal; and
coupling the mounting section with the tray.

15. The method according to claim 14, wherein
the plurality of partition plates has end sections thereof having projections, respectively,
the box section has an outer periphery having a plurality of holes provided therein,
said providing of the tray by coupling the plurality of partition plates with the box section comprises engaging the plurality of projections of the plurality of partition plates with the plurality of holes of the outer periphery of the box section, respectively.

16. The method according to claim 15, wherein said providing of the tray by coupling the plurality of partition plates with the box section further comprises engaging the plurality of projections of the plurality of partition plates with the plurality of holes of the outer periphery of the box section, respectively and crimping the plurality of projections.

17. The method according to claim 15, wherein said providing of the tray by coupling the plurality of partition plates with the box section further comprises bending the outer periphery of the box section as to crimp the end sections of the partition plates with the bent outer periphery.

18. The method according to claim 14, wherein said providing of the tray by coupling the plurality of partition plates with the box section comprises bending an outer periphery of the box section as to crimp the end sections of the partition plates by the bent outer periphery.

19. The method according to claim 14, further comprising
after said providing of the tray by coupling the plurality of partition plates with the box section, providing a film on the box section and the partition plates, the film covering a boundary between the box section and the partition plates.
